(19) United States
(12) Patent Application Publication
(10) Pub. No.: US 2008/0065469 A1
(43) Pub. Date: Mar. 13, 2008

(54) METHOD AND APPARATUS FOR GENERATING RECOMMENDATIONS FOR CONSUMER PREFERENCE ITEMS

(76) Inventors: Jeffrey P. Specter, New York, NY (US); Billy A. Richwine II, Sante Fe, NM (US)

Correspondence Address: LAW OFFICES OF PAUL E. KUDIRKA, 40 BROAD STREET, SUITE 300, BOSTON, MA, 02109, US

(21) Appl. No.: 11/852,451

(22) Filed: Sep. 10, 2007

Related U.S. Application Data
(63) Continuation of application No. 09/785,847, filed on Feb. 16, 2001, now abandoned.

(51) Int. Cl. G06Q 30/00

(52) U.S. Cl. 705/10

(57) ABSTRACT

In order to make consumer preference item recommendations, a database is created from consumer preference tests in which a large number of respondents comparatively rate a large number of items based on personal preference. The database contains calculated distances between each pair of items based on the respondent preference ratings. A profile procedure based on inputs from a single customer generates profile sample items that the customer prefers. These profile sample items are then applied as inputs to the database and items in the database within a predetermined distance from the profile sample items are recommended to the customer.

### FIELD OF THE INVENTION

This invention relates to consumer preference items, such as music, movies, fashions, books, television shows and other entertainment choices, and to methods and apparatus for receiving inputs from a user and generating recommendations for such items where the recommended items have a high probability that the user will like them.

### BACKGROUND OF THE INVENTION

In many areas that involve consumer preferences it is often difficult for the consumer to select items from a large variety of items available in order to create a preferred collection of items. This difficulty is often compounded where the number of available items is so large that it is not possible for the consumer to personally review each item in order to make a decision whether the item is preferred. For example, a consumer may listen to music and enjoy certain songs. However, with the thousands of songs that are available to any given consumer, it is generally not possible for that consumer to select preferred songs unless the song has been heard or the artist is known, etc. Most consumers simply do not have time to listen to thousands of songs in order to form preference opinions. Further, in many cases, the user may have to buy the items, resulting in large expenditures in order to even attempt a selection. The same problem occurs with movies, television shows and other consumer preference items where a consumer forms a subjective preference, or liking, for individual items and wants recommendations to other similar items in order to review them.

Several prior art attempts have been made to solve this problem. One such prior art approach has been to categorize preference items and then, when a consumer indicates a preference for one item in such a category, other items in the same category are recommended to the consumer. Such an approach is common in on-line shopping services where the goods to be sold are categorized. When a shopper buys an item in a category, such as a music CD, other CDs are recommended to the shopper, the next time the shopper logs on to the site. Alternative selections performed by the same artist or artists that composed the music that was purchased by the shopper may also be recommended. Suggestions may also be made from categories that contain preference items that have been previously selected by a “professional” or “expert” who has reviewed the items and placed them into categories. These prior art systems can make recommendations that are at least within the general area that is of interest to the consumer. However, the categories are generally broad and, thus, the recommendations are usually only peripherally related to the consumers actual preferences.

Similar systems can be used to recommend songs. For example, a consumer may be asked questions in order to determine musical preferences for selected musical “genres”, such as popular, jazz, classical, etc or “moods.” Once a genre has been selected, the system will select a short list of songs from song collections or albums that have been previously classified as with the selected genre by a music professional or expert as discussed previously. Such a system is available from Mubu.com or Savagebeast.com, for example. Still other systems, such as Moodlogic.com, allow other consumers to log onto a website and classify the songs.

Other prior art solutions use a known database search engine to perform a search, such as a word or text search to locate preference items. The results are then refined based on the “popularity” of the items discovered so that the relative ranking of the located items that are more popular are varied depending on the type of search. Such a system is disclosed in U.S. Pat. No. 6,006,218.

Still other solutions use varying forms of digital signal analysis to evaluate preference items, such as songs. In this approach, sample songs that have been indicated as preferred by a customer are analyzed to determine characteristics, such as beats per minute and selected beat patterns. The characteristics are then compared to a database of characteristics generated from a large collection of songs. Songs in the database with statistically similar characteristics are grouped with the sample songs and recommended to the consumer. Examples of systems that operate in this manner are provided by Mongomusic.com, Gigabeat.com, Savagebeast.com and Cantametrix.com.

While the aforementioned systems do generate recommendations, they are relatively crude and inaccurate and are capable of generating only a limited number of recommendations. Therefore, there is a need for a recommendation system that can generate substantial numbers of recommended items that accurately reflect a consumer's preferences.

### SUMMARY OF THE INVENTION

In accordance with the principles of the invention, one illustrative embodiment uses a database of consumer preference items, such as songs, movies or television shows to generate the recommendations. The database is created from consumer preference tests in which a large number of respondents comparatively rate a large number of items. The database contains calculated distances between each pair of items based on the respondent preference ratings.

In order to make recommendations from the database, a profile procedure based on inputs from a customer generates profile sample items that the customer prefers. These profile sample items are then applied as inputs to the database and items in the database within a predetermined distance from the profile sample items are recommended to the customer.

In one embodiment, the distance used to determine the recommendations from the database is fixed and the number of items recommended can be changed by varying the distance, and, in another embodiment, the distance can be modified by the customer.

In still another embodiment, the recommended items are displayed to the customer as feedback from the system and the customer can then change the profile sample items to refine or expand the recommendations.

In yet another embodiment, the customer interacts with a local terminal, which performs the profile procedure, and the database is contained in a remote server that may be connected to the local terminal by a network, such as the Internet.

### BRIEF DESCRIPTION OF THE DRAWINGS

The above and further advantages of the invention may be better understood by referring to the following description in conjunction with the accompanying drawings in which:

FIG. 1 is a block schematic diagram showing an illustrative computer system on which the inventive recommendation system can run.

FIG. 2 is a block schematic diagram showing an overall view of one embodiment of the inventive recommendation system.

FIG. 3 is a flowchart showing the steps in a recommendation process that operates in accordance with FIG. 2.

FIG. 4 is a flowchart showing the steps in an illustrative process for generating a customer profile.

FIG. 5 is a flowchart showing the steps in an illustrative process for generating database entries.

### DETAILED DESCRIPTION

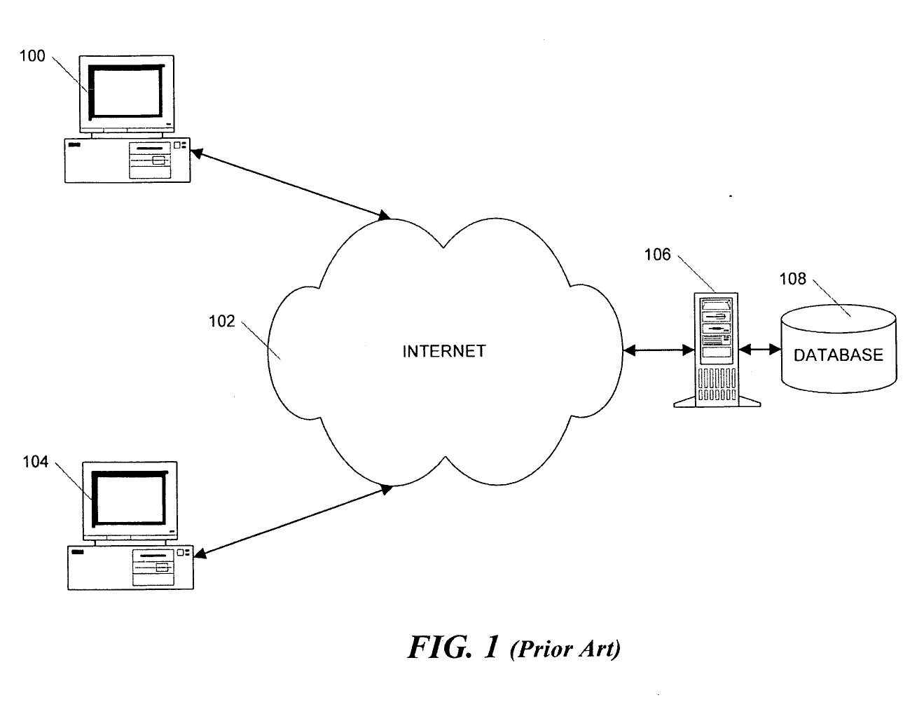

FIG. 1 illustrates, in schematic form, a computer system suitable for implementing the inventive preference item recommendation system. In the system shown in FIG. 1, local terminals, of which terminals 100 and 104 are shown, accept input from customers and display recommendations, and are located in areas that are convenient to customers. For example, these terminals may be located in a customer's home, in or near retail outlets that sell items for which recommendations are generated, in kiosks, etc. Terminals 100 and 104 may be personal computer systems, display terminals, wireless apparatus or other display mechanisms. As will be hereinafter described, a customer wishing to use the inventive music recommendation system, enters sample preference information into a local terminal, such as terminal 100. Terminal 100 then generates a customer “profile” for that particular customer. The customer profile is forwarded over a network, such as the Internet, to a server 106 that may be located remotely.

The server 106 compares the customer profile generated at the terminal 100 to a database of preference item information 108 and identifies items that are similar to the preference items specified in the customer's profile as indicated by pre-calculated distance values in the database 108. The identified items are used as recommendations. When the recommendations have been obtained, server 106 forwards them back to local terminal 100, again via the network 102, for display to the customer. The customer then may accept the recommendations or may revise the sample preferences entered into the system in order to change the customer profile and generate new recommendations. For example, the customer may use the recommendations as new sample preferences information to create a new, more focussed profile. If the profile is changed, the new profile is sent, via network 102 to server 106 and again compared to the preference item information stored in database 108 and the results returned. Calculations of the distance values in database 108 are based on the results of a consumer preference study conducted with other consumers, rather than professionals or experts, as discussed in detail below.

The computer system shown in FIG. 1 is illustrative and other configurations that differ both architecturally and operationally can also be used with the present invention without departing from the spirit and scope of the invention. For example, the customer profile generator that runs in local terminal 100 and the server program that runs in server 106 may, in fact, run in the same computer so that the entire system operates on a single computer that might be located in a kiosk, for example. In addition, a LAN, WAN or other network may be used in place of the Internet 102 as shown in FIG. 1. Further, the customer profile generator could also be located in a website accessed by the customer over the Internet.

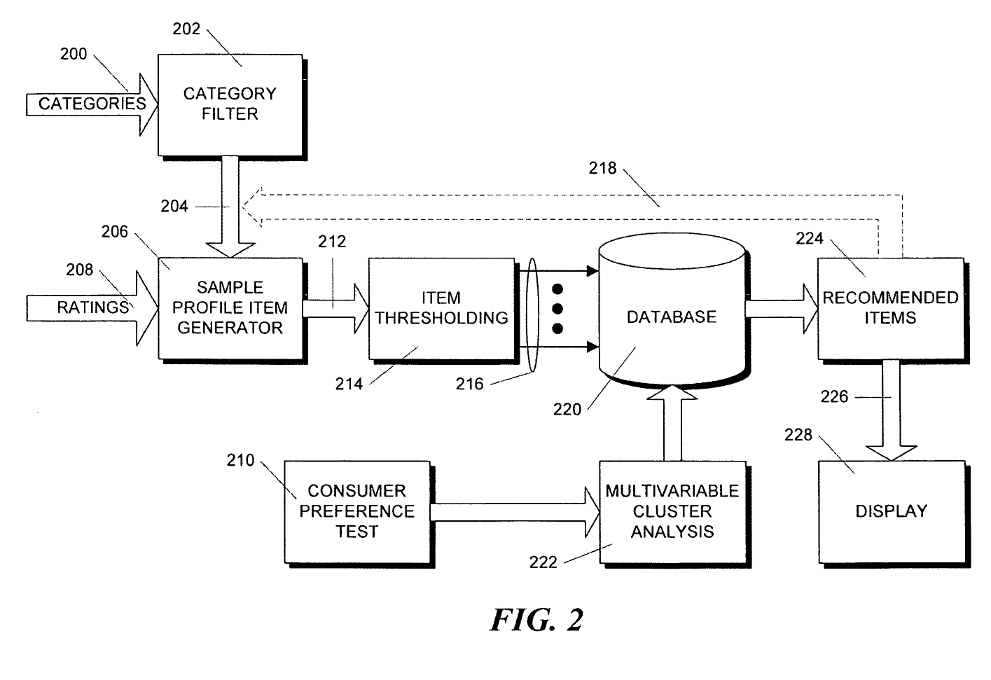

FIG. 2 illustrates, in a schematic form, a recommendation process that operates in accordance with the principles of the present invention. The process begins when a customer enters information into a terminal, such as terminal 100, shown in FIG. 1. The purpose of this information is to develop sample preference items that represent a customer's preferences in a given area, such as music. Those skilled in the art would know that these sample preferences could be ascertained in a number of ways. One method to obtain these sample items would be to elicit from the customer the names of some items that the customer likes. However, in many cases the customer may be able to identify some items, but not enough items to form a basis for making recommendations. Consequently, in one embodiment of the invention, the customer is prompted to respond to displayed choices. In this manner, the customer will be guided to selecting enough sample preference items so that accurate recommendations can be generated. In general, the displayed choices are arranged to reduce or filter the choices so that the profiling process generates enough sample preference items to make accurate recommendations, but the customer does not have to take a complete customer preference test. In particular, in one embodiment, the customer enters information in response to choices displayed at the terminal by a category filter 202. The displayed choices structure the information entered by the customer and reduce the amount of information that must be entered in order to simplify the generation of the customer profile. The choices made by the customer enable a profile to be generated for this particular customer.

The selections presented to the customer may act as a filter or screening device to quickly reduce the possible number of choices and make the information entry faster. For example, the first choices displayed can be a plurality of broad item categories that define potential areas of interest to the customer. Categories that are not selected by the customer allow the profile generator to eliminate classes of items that are of no interest to the customer. In order to ensure complete coverage of all possible items, the category choices are broad format descriptors that represent all of the items in the database 214. For example, in the case of a music recommendation system, the category choices might be music styles, such as 1) new popular; 2) old popular; 3) new rock; 4) old rock; 5) country; 6) smooth jazz; 7) oldies; 8) hip hop; and 9) rhythm and blues. The aforementioned categories are for purposes of illustration only; different categories could be used that would be known to be equivalent by those skilled in the art.

The displayed categories may also include additional information that will indicate the types of items in the category and assist the customer in deciding whether to select that category. For example, in the case of a music system, each category, or music style, may have a list of artists who have recorded songs in that category displayed along with the category name so that the consumer can associate brand names with the category name.

In response to the category display, the customer may select one or more categories that are of interest to him. The customer category selections are indicated schematically in FIG. 2 as arrow 200 and are provided to the category filter 202. The category filter 202 provides the category selections as indicated by arrow 204 to a sample profile item generator 206 that further refines the customer profile by generating and displaying a plurality of profile sample items for each selected category. Each profile sample item consists of information identifying a preference item that represents a subset or a substyle of each selected category. In the case of a music recommendation system, the profile sample items can be representative songs from several substyles in each music category. For example, if the customer selected the “new popular” music category referenced above, the following songs and artists might be displayed:

| | Artist | Title | Rating |
|---|---|---|---|
| 1. | Brittany Spears | Oops! | 1 2 3 4 5 |
| 2. | N'Sync | Bye Bye Bye | 1 2 3 4 5 |
| 3. | Sugar Ray | Every Morning | 1 2 3 4 5 |
| 4. | Brian McNight | Back to One | 1 2 3 4 5 |
| 5. | Pink | There You Go | 1 2 3 4 5 |
| 6. | Vertical Horizon | Everything | 1 2 3 4 5 |
| 7. | Santana | Smooth | 1 2 3 4 5 |

Again, the aforementioned items are for purposes of illustration only and other arrangements within the skill of the art could be used. In general, a small number, for example 2-3 items, will be displayed for each distinct substyle represented in the category, although more or less items could be used. The customer is then asked to rate each of the displayed profile sample items with a predetermined rating scale (1-5 in the example given above.) The system may assist in this rating by allowing the customer to hear or see short excerpts of the preference item. The customer's ratings are schematically indicated by arrow 208 and allow the system to judge the customer's substyle preference.

When the profile sample items in all of the selected categories have been rated by the customer, the ratings information indicated by arrow 212 in FIG. 2 is applied to an item thresholding operation as indicated by box 214. In particular, the number of profile sample items selected by the generator 206 is reduced by discarding all of those items where the customer's rating falls below a predetermined threshold. For example, in the aforementioned music recommendation system, the thresholding operation 214 may discard all profile sample items having a rating of less than 4 so that all remaining sample profile items have customer ratings of 4 and 5. Alternatively, the thresholding operation may use low scores to assist in the creation of a final profile by weighting each song by its score or a number derived from the score in order to arrive at an adjusted score or preference. Other alternative arrangements would be obvious to those skilled in the art.

Information identifying the profile items selected by means of the customer's input, schematically illustrated as arrows 216, is then provided to the recommendation database 220. As previously mentioned, the database 220 contains information identifying a large number of consumer preference items arranged and a difference table that contains calculated differences between pairs of the items such that the table holds difference values that represent the differences between a given item and all other items in the database. In accordance with the principles of the invention, the calculated differences are determined from ratings obtained in a consumer preference test conducted with other consumers. The preference test may be conducted before a live audience comprising a plurality of consumers who take the test together or the consumers may take the test individually at different times, for example, by logging onto a specialized website. In any case, a statistically significant number of consumers should take the test. The database is compiled so that it contains information on all of the preference items that can be identified in customer profiles and, of course, many more additional items that will form the basis for the recommendations.

More specifically, the consumer preference test 210 may consist of a single test or a plurality of tests. In one embodiment, in each test, a consumer audience comprising for example 50-100 respondents is asked to rate a set of consumer preference items on a predetermined rating scale. For example, each of 100 respondents may be asked to rate 500 songs by listening to each song and rating the song as to whether they like the song, they are neutral about the song or they do not like the song. All of the ratings information is then used to generate the difference table using a conventional multi-variable analysis operation 222. In general, the database information would be periodically compiled in order to add new items. The frequency of such compilation would depend on the frequency at which new preference items are introduced. For example, in a music recommendation system, database 220 might be recompiled every six months in order to add new songs to the database and to adjust preference scores or add new preference scores.

In accordance with the principles of the invention, the ratings used during the consumer preference test measure each respondent's preference for a particular song, that is, whether the respondent subjectively “likes” or “dislikes” the song. This preference rating is in contrast to prior rating systems which ask respondents to categorize each song by music category, such as jazz, pop, etc or by some other category such as “mood” (romantic, bouncy, etc.) Preference ratings have been found to give recommendations that are more accurate because a particular customer may still “like” two songs even if they are in different categories. More particularly, it has been found that, if many consumers like both of two songs, there is a substantial probability that another customer who likes one of the songs will also like the other song.

In the analysis operation 222, for each pair of consumer preference items, the distance between the items, measured as the difference in the ratings, is calculated for every respondent in the consumer preference test. The square of each difference is then summed. This distance becomes the Euclidean distance squared in N-dimensional space where N is the number of valid respondents. The distance used in the distance table may then be taken as the square root of the results, which is the Euclidean distance or some other measure such as the Euclidean distance squared. Those skilled in the art would realize that other distance measures, such as Chi-square, variance, Bayesian and other known distance measures, or combinations thereof, could be used in place of, or in addition to, the Euclidian distance measure discussed above to arrive at a final “distance” measure. An arbitrary scale may be used for the ratings. For example, negative opinions, which means the respondent dislikes the preference item, may be rated at minus 1; no opinion at 0; preferred opinions at 1 and favorites at 1.5. Conventional analysis software can be used to generate the difference table. For example, software, which is suitable for performing the above analysis, is marketed under the name “Variety Control” by Steve Casey Research, 663 Washington Avenue, Santa Fe, N. Mex. 87501. After the computations are completed, a table, which identifies each pair of songs and specifies the distance measurement between each pair of songs, is stored in database 220.

Then the profile sample item information, which is generated by the item thresholding step 214 as indicated by arrows 216, is applied to the database 220 by a recommendation unit 224 that matches information identifying each profile sample item with information identifying a corresponding item in the database and then selects other preference items in the database where the distance from the profile sample item to the other items is less than or equal to a predetermined distance. This process is repeated for each profile sample item in order to produce a collection of recommended preference items that are indicated by arrow 226 in FIG. 2. For example, in a music recommendation system, song titles and artists produced by the profile generation process are used to select songs located within a predetermined distance in the database. The titles and artists of these selected songs are then returned as recommendations. These recommendations may be then displayed as indicated in the box 228. Information identifying the recommended items may also be returned to the customer, as indicated by schematically by arrow 218, to modify or replace the profile sample items displayed for each category and, therefore, to refine the search.

While it might initially appear that, during a consumer preference test, each respondent's ratings of the items may have no relation to another respondent's ratings, it has been found that many items in the test, in fact, do belong together in the sense that they are liked and disliked by substantially the same test respondents. Thus, as the distance between two preference items decreases, it is likely that a person, such as the customer who is requesting recommendations, who indicates a preference for one item will also prefer the other item. Consequently, the inventive method generates accurate results in that the recommendations produced are generally preferred by the customer.

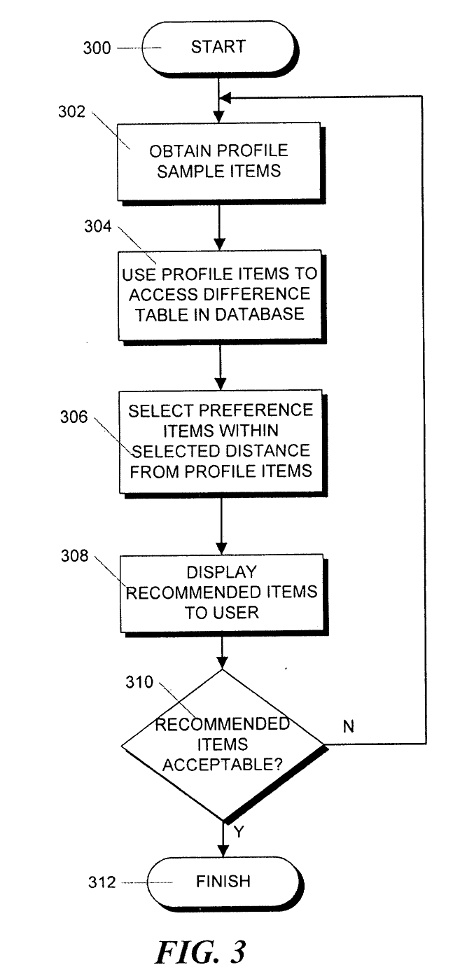

FIG. 3 is a flowchart that gives an overview of the inventive recommendation process. The process starts in step 300 and proceeds to step 302 where information identifying sample profile items is obtained from a customer by means of the profiling process described in connection with FIG. 2, blocks 202, 206 and 214. The sample profile item information is then applied to the difference table in the database 220 as indicated in step 304. In step 306, recommended preference items in the database 220 are selected by choosing items within a selected distance from the sample profile items.

Next, in step 308, information identifying the recommended items is displayed to the user. In step 310, the customer makes a determination whether the recommended items are acceptable. If so, the process finishes in step 312. If not, the process returns to step 302 where, for example, the recommended items may be used to modify the subcategory choices displayed during the profile generation process or may be displayed as the subcategory choices. A customer may then rate these new choices to obtain new sample profile items in step 302. Steps 304-310 are then repeated until acceptable recommendation items are obtained.

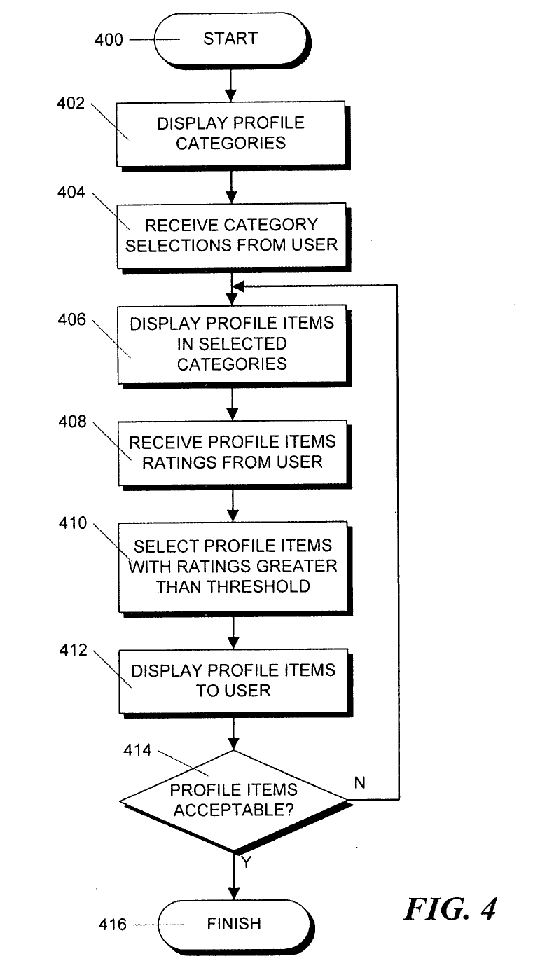

FIG. 4 is a flowchart that shows, in more detail, a process for generating profile items as described above in connection with FIG. 2. In particular, the process starts in step 400 and proceeds to step 402 where profile categories are displayed to the user, for example on the local terminal 100 or by another means.

In step 404, category selections are made by, and received from, the customer, for example, by using a keyboard, mouse or other selection device.

Next in step 406, profile items corresponding to subclasses of each category are displayed and, in step 408, ratings of each of the displayed profile items are received from the user, again by means of a keyboard, mouse or other selection device.

In step 410, a thresholding process is used to select profile items with ratings greater than a predetermined threshold value. In step 412, the selected profile items are displayed to the customer to allow the customer to confirm his choice. In step 414, the customer makes a determination whether the selected profile items are acceptable. If so, the process finishes in step 416. If not, the process returns back to step 406 in which the profile items in the selected categories are redisplayed to allow the user to re-rate the items in order to refine the profile. Steps 408-414 are then repeated until acceptable profile items are obtained and the process finishes in step 416.

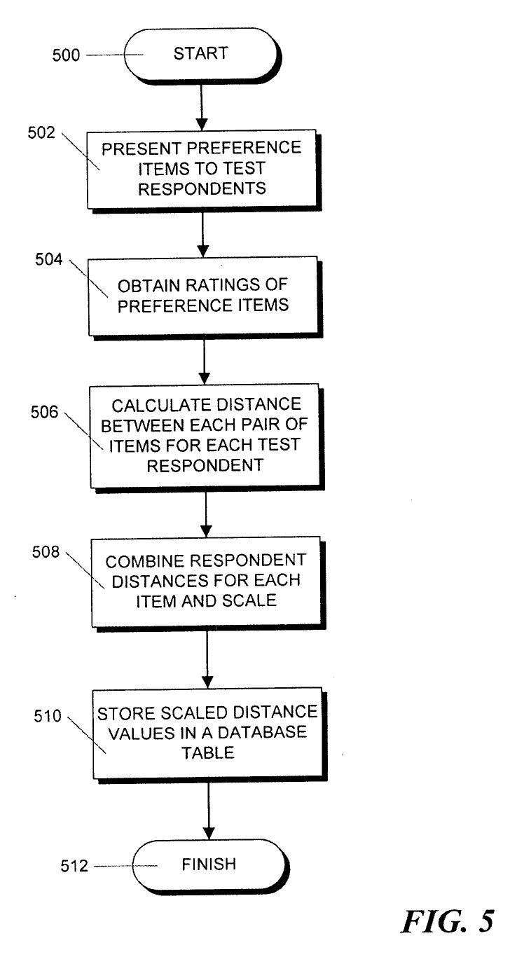

FIG. 5 is a flowchart that illustrates, in more detail, the creation of the distance table in the recommendation database 220 in accordance with the principles of the present invention. This process starts in step 500 and proceeds to step 502 where a consumer preference test is conducted on a plurality of consumers. The consumers may consist of paid or unpaid respondents. For example, a preference test may consist of 100 respondents. In step 502, representative preference items are presented to the test respondents. For example, the respondents may be asked to rate 500 songs each. A typical manner of performing such a test is to play the songs, or portions of the songs, in an auditorium. Alternatively, the songs may be played for each consumer individually if the consumers take the test individually. Each respondent listens to the song and then rates the song. Such a test is called an “auditorium test”. Similar tests can be used for movies, television shows or other consumer preference items.

Next in step 504, ratings of each of the survey items are obtained from each of the test respondents. In general, such ratings may consist of a numerical rating, a rating scale or a like/don't like rating. Next, in step 506, the distance between each pair of preference items is calculated for each test respondent. As previously mentioned, this distance can be simply calculated by subtracting the difference between the rating scores for each pair of respondents.

Next, as indicated in step 508, the distances for each pair of preference items are combined, for example, by squaring and summing the distances and then possibly scaling the distances, for example, by adjusting the differences to fit on a predetermined scale. Next, in step 510, information identifying each preference item and the scaled distances are stored in the database table. The routine then finishes in step 512.

A software implementation of the above-described embodiment may comprise a series of computer instructions either fixed on a tangible medium, such as a computer readable medium, e.g. a diskette, a CD-ROM, a ROM memory, or a fixed disk, or transmissible to a computer system, via a modem or other interface device over a medium. The medium either can be a tangible medium, including, but not limited to, optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web or cellular links.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, although the description was directed to particular preference items, such as songs, movies or television shows, that almost any item for which a customer can form a subjective like or dislike is amenable to the inventive recommendation process. Other aspects, such as the specific instructions utilized to achieve a particular function, as well as other modifications to particular processes or routines used to achieve a function are intended to be covered by the appended claims.

What is claimed is:

1. A method for generating recommendations for consumer preference items, comprising:
(a) generating information identifying a plurality of profile sample items based on selections made by a customer;
(b) applying the profile sample item information as an input to a recommendation database, the database storing information identifying a plurality of preference items and distances between pairs of items, the distances being calculated from preference ratings obtained from a consumer preference test; and
(c) recommending to the customer consumer preference items that are located in the database within a predetermined distance from the profile sample items.

2. The method of claim 1 step (a) comprises
(a1) receiving a plurality of item category selections from the customer, each item category representing an area of potential interest to the customer;
(a2) displaying information identifying a plurality of sample preference items representing subclasses in each category; and
(a3) selecting sample preference items based on information received from the customer.

3. The method of claim 2 wherein step (a3) comprises receiving a rating from the customer for each displayed sample preference item and selecting sample preference items based on the received rating.

4. The method of claim 1 wherein the consumer preference test is conducted before a live audience.

5. The method of claim 1 wherein the consumer preference test is conducted individually respondent by respondent with a plurality of respondents and each respondent rates each of a plurality of preference items.

6. The method of claim 1 wherein a distance in the database is calculated between a pair of preference items by calculating the difference in preference ratings between the pair of preference items for each respondent and combining the preference rating differences for all respondents.

7. The method of claim 6 wherein the distances are scaled to fall within a predetermined range.

8. The method of claim 1 wherein step (c) comprises displaying the recommended items to the customer.

9. The method of claim 1 wherein step (a) comprises generating information identifying a plurality of profile sample items based on selections made by a customer and on information identifying items recommended in step (c).

10. The method of claim 1 wherein step (a) further comprises generating information identifying a plurality of profile sample items by displaying information identifying items recommended in step (c) to a customer, receiving a rating from the customer for each displayed item and using the received ratings to generate the information identifying a plurality of profile sample items.

11. The method of claim 1 wherein the preference items are songs.

12. The method of claim 1 wherein the preference items are movies.

13. The method of claim 1 wherein the preference items are television shows.

14. The method of claim 1 wherein the preference items are books.

15. The method of claim 1 wherein the preference items are fashions.

16. Apparatus for generating recommendations for consumer preference items, comprising:
a profile generator that generates information identifying a plurality of profile sample items based on selections made by a customer;
a recommendation database that receives the profile sample items as inputs, the database storing information identifying a plurality of preference items and distances between pairs of items, the distances being calculated from preference ratings obtained from a consumer preference test; and
a recommendation unit that recommends to the customer consumer preference items that are located in the database within a predetermined distance from the profile sample items.

17. The apparatus of claim 16 wherein the profile generator comprises:
a category generator that receives a plurality of item category selections from the customer, each item category representing an area of potential interest to the customer;
a sample profile item generator that displays information identifying a plurality of sample preference items representing subclasses in each category; and
an item thresholding unit that selects sample preference items based on information received from the customer.

18. The apparatus of claim 17 wherein the sample item profile generator comprises an input mechanism for receiving a rating from the customer for each displayed sample preference item and the item thresholding unit selects sample preference items based on the received ratings.

19. The apparatus of claim 16 wherein the consumer preference test is conducted before a live audience.

20. The apparatus of claim 16 wherein the consumer preference test is conducted individually respondent by respondent with a plurality of respondents and each respondent rates each of a plurality of preference items.

21. The apparatus of claim 16 wherein a distance in the database is calculated between a pair of preference items by calculating the difference in preference ratings between the pair of preference items for each respondent and combining the preference rating differences for all respondents.

22. The apparatus of claim 21 wherein the distances are scaled to fall within a predetermined range.

23. The apparatus of claim 16 wherein the recommendation unit comprises a display that displays the recommended items to the customer.

24. The apparatus of claim 16 wherein the profile generator generates information identifying a plurality of profile sample items based on selections made by a customer and on information identifying recommended items calculated by the recommendation unit.

25. The apparatus of claim 16 wherein the profile generator comprises a display that displays recommendations generated by the recommendation unit to a customer, an input mechanism that receives a rating from the customer for each displayed item and the item thresholding unit selects sample preference items using the received ratings.

26. The apparatus of claim 16 wherein the preference items are songs.

27. The apparatus of claim 16 wherein the preference items are movies.

28. The apparatus of claim 16 wherein the preference items are television shows.

29. The apparatus of claim 16 wherein the preference items are books.

30. The apparatus of claim 16 wherein the preference items are fashions.

31. A computer program product for generating recommendations for consumer preference items, the computer program product comprising a computer usable medium having computer readable program code thereon:
program code for generating information identifying a plurality of profile sample items based on selections made by a customer;
program code for applying the profile sample item information as an input to a recommendation database, the database storing information identifying a plurality of preference items and distances between pairs of items, the distances being calculated from preference ratings obtained from a consumer preference test; and
program code for recommending to the customer consumer preference items that are located in the database within a predetermined distance from the profile sample items.

32. The computer program product of claim 31 further comprising program code for generating the recommendation database information.

33. The computer program product of claim 32 wherein the consumer preference test is conducted with a plurality of respondents and each respondent rates each of a plurality of preference items and wherein the program code for generating the database information comprises program code for calculating a distance in the database between a pair of preference items by calculating the difference in preference ratings between the pair of preference items for each respondent and combining the preference rating differences for all respondents.
